(19) United States
(12) Patent Application Publication
(10) Pub. No.: US 2024/0049663 A1
(43) Pub. Date: Feb. 15, 2024

(54) WATERING DEVICE

(71) Applicant: STACKWATER LLC, Clinton, ID (US)

(72) Inventors: SPENCER C. MADSEN, Sandy, UT (US); JACOB C. HILLER, Centerville, UT (US); JACOB B. PORTER, Clinton, UT (US); CALEB J. HILLER, Centerville, UT (US)

(73) Assignee: STACKWATER LLC, Clinton, ID (US)

(21) Appl. No.: 18/449,570

(22) Filed: Aug. 14, 2023

Related U.S. Application Data
(60) Provisional application No. 63/397,608, filed on Aug. 12, 2022.

(51) Int. Cl. A01G 27/00; A01G 27/02

(52) U.S. Cl. CPC A01G 27/006; A01G 27/02

(57) ABSTRACT

Apparatuses, systems, and methods are disclosed for a watering device. An apparatus includes a liquid reservoir. An apparatus includes a liquid permeable cone in fluid communication with a liquid reservoir. An apparatus includes one or more threads circumscribing a liquid permeable cone such that rotation of the one or more threads into soil places the liquid permeable cone into contact with the soil.

### CROSS-REFERENCE TO RELATED APPLICATIONS

This application claims the benefit of U.S. Provisional Patent Application No. 63/397,608 entitled “WATERING DEVICE” and filed on Aug. 12, 2022, for Spencer C. Madsen, et al., which is incorporated herein by reference in its entirety for all purposes.

### FIELD

This invention relates to fluid flow and more particularly relates to a watering device for placement in soil.

### BACKGROUND

Watering plants or keeping soil moist for other purposes (e.g., curing concrete, or the like) can be a tedious process. Forgetting manual watering can harm or kill plants, and automated electrical watering systems can be complex and/or expensive, and electricity may not be available at all watering locations.

### SUMMARY

Apparatuses, systems, and methods are disclosed for a watering device.

Apparatuses are disclosed for a watering device. In certain embodiments, an apparatus includes a liquid reservoir. In one embodiment, an apparatus includes a liquid permeable cone in fluid communication with a liquid reservoir. An apparatus, in some embodiments, includes one or more threads circumscribing a liquid permeable cone so that rotation of the one or more threads into soil places the liquid permeable cone into contact with the soil.

Additional apparatuses are disclosed for a watering device. In one embodiment, an apparatus includes a liquid reservoir. An apparatus, in some embodiments, includes a removable lid for a liquid reservoir. In certain embodiments, an apparatus includes a liquid permeable cone in fluid communication with a liquid reservoir, the liquid permeable cone comprising a ceramic material. An apparatus, in one embodiment, includes one or more threads circumscribing a liquid permeable cone so that rotation of the one or more threads into soil places the liquid permeable cone into contact with the soil. One or more threads, in some embodiments, comprise a different material than a liquid permeable cone and are placed to provide mechanical support to the liquid permeable cone. In a further embodiment, an apparatus includes an interface between one or more of a liquid permeable cone and one or more threads and a liquid reservoir.

Systems are disclosed for a watering device. A system, in certain embodiment, includes a plurality of stackable liquid reservoirs. In one embodiment, a system includes a liquid permeable cone in fluid communication with a plurality of liquid reservoirs. A system, in some embodiments, includes one or more threads circumscribing a liquid permeable cone so that rotation of the one or more threads into soil places the liquid permeable cone into contact with the soil.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a watering device;

FIG. 2 is a side view illustrating a further embodiment of a watering device;

FIG. 3 is a top view illustrating another embodiment of a watering device; and

FIG. 4 is a bottom view illustrating one embodiment of a watering device.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are included to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

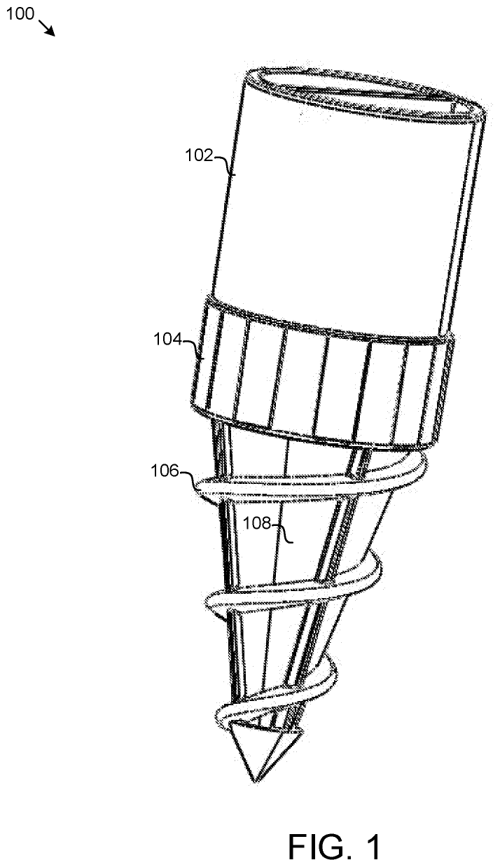

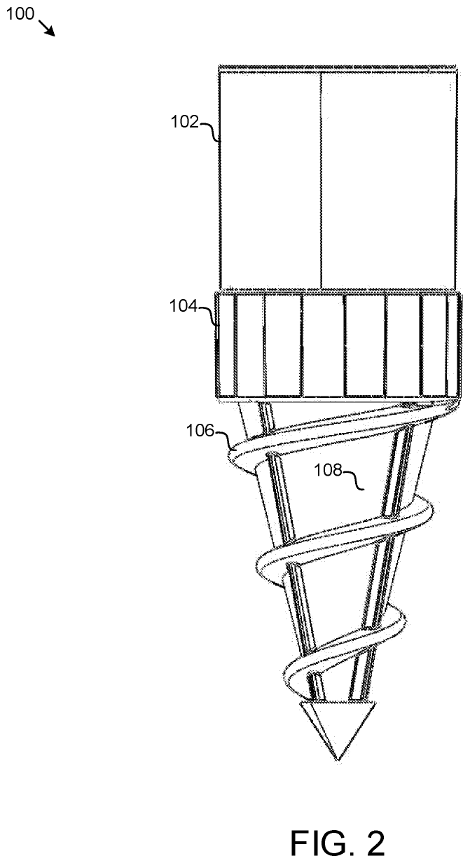

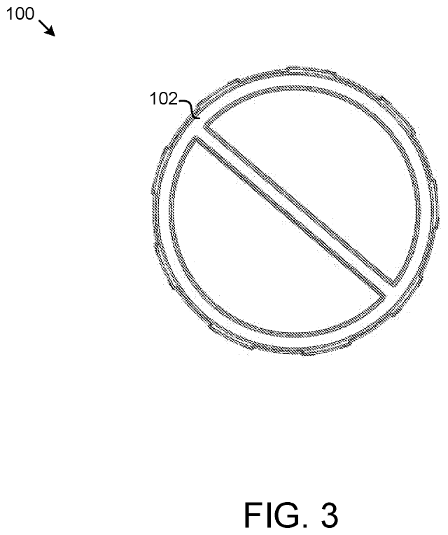

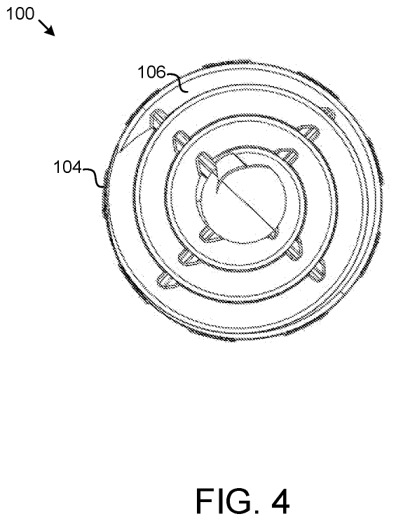

FIGS. 1-4 depict various embodiments of an apparatus 100 for watering. In the depicted embodiment, the apparatus 100 includes a liquid reservoir 102, an interface 104, one or more threads 106, and a liquid permeable cone 108. In general, the liquid reservoir 102 may store water or another liquid, and the one or more threads 106 may anchor and/or otherwise place the liquid permeable cone 108 in contact with soil, such that the water or other liquid in the liquid reservoir 102 flows through the liquid permeable cone 108 into the surrounding soil (e.g., at a flow rate, a transfer rate, or the like).

The one or more threads 106, in certain embodiments, are affixed to, coupled to, and/or adjacent to the liquid permeable cone 108. In some embodiments, the one or more threads 106 may provide mechanical support for the liquid permeable cone 108, may strengthen and/or reinforce the liquid permeable cone 108, may stabilize the liquid permeable cone 108 in soil, or the like (e.g., to decrease a likelihood of breakage of the liquid permeable cone 108, or the like). For example, the one or more threads 106 may substantially circumscribe the liquid permeable cone 108 so that rotation of the one or more threads into soil places the liquid permeable cone 108 into contact with the soil (e.g., may act as an auger screwing the liquid permeable cone 108 into the soil, allowing for easier and/or deeper placement into the soil, or the like).

In some embodiments, the one or more threads 106 and the liquid permeable cone 108 comprise different materials. For example, in one embodiment, the liquid permeable cone 108 may comprise a ceramic material, a terra cotta material, a sponge material, a paper material, a cardboard material, a mesh material, a wicking material, a fabric material, a porous material, and/or another liquid permeable material and the one or more threads 106 may comprise a metallic material, a plastic or other polymer material, a wooden material, and/or another sturdy material.

The interface 104 may be fixedly and/or removably coupled to the one or more threads 106 and/or to the liquid permeable cone 108 and may couple one or both to the liquid reservoir 102 so that liquid from the liquid reservoir 102 flows to the liquid permeable cone 108. The interface 104, in some embodiments, may provide a seal between the liquid reservoir 102 and the liquid permeable cone 108. In other embodiments, the interface 104 may be liquid permeable and may work together with the liquid permeable cone 108 to allow liquid from the liquid reservoir 102 to enter surrounding soil. The interface 104, in certain embodiments, may comprise one or more interior threads formed to interface with corresponding threads disposed on the liquid reservoir 102, may comprise complimentary post and slot connectors, may be welded or fused to the liquid reservoir 102, may be adhered to the liquid reservoir with an adhesive, may be formed from the same continuous material and integrated with the one or more threads 106 and/or with the liquid reservoir 102, or the like. The interface 104, in the depicted embodiments, includes one or more grips and/or ridges disposed on a surface of the interface 104 (e.g., to provide grip to a user rotating the interface 104 to place the one or more threads 106 and/or the liquid permeable cone 108 into the soil).

The liquid reservoir 102, in some embodiments, may comprise a lid and/or cap (e.g., to slow or prevent evaporation, to prevent contaminants from entering the liquid reservoir 102, to prevent insects or other pests from entering and/or laying eggs in the liquid reservoir 102, or the like). A lid and/or cap may be removable, to allow refilling of the liquid reservoir 102 in place (e.g., while placed in surrounding soil, or the like). In a further embodiment, the apparatus 100 may include multiple, stackable, liquid reservoirs 102, shaped to removably interface with each other in a stackable manner (e.g., with a gravity interface, a friction fit interface, a threaded interface, or the like between them). Multiple, stackable liquid reservoirs 102 may supplement a liquid storage capacity of the first liquid reservoir 102, allowing a user to dynamically set, supplement, and/or expand a liquid storage capacity of the apparatus 100 as desired (e.g., to extend a watering timeline, to provide more water, or the like.

The liquid reservoir 102, in one embodiment, may comprise an at least partially transparent and/or translucent material, so that contents of the liquid reservoir 102 (e.g., a liquid level) are visible and/or observable outside the liquid reservoir 102 (e.g., to a user). For example, the liquid reservoir 102 may comprise a transparent and/or translucent plastic or other polymer material, glass material, or the like.

In a further embodiment, the apparatus 100 may comprise a float or other indicator, actuated by a liquid level within the liquid reservoir 102 and/or the liquid permeable cone 108, indicating the liquid level within the liquid permeable cone 108 even if the liquid permeable cone 108 is not transparent, is below soil, or the like. For example, the float or other indicator may at least partially extend up from within the liquid permeable cone 108 into the liquid reservoir 102, where a user may observe a level of the float through the liquid reservoir 102.

In some embodiments, the apparatus 100 waters surrounding soil and/or plants without using electricity and may be usable where electrically controlled watering systems are not. The apparatus 100, in one embodiment, may be used indoors (e.g., in soil around an indoor potted plant, or the like). In a further embodiment, the apparatus 100 may be used outdoors (e.g., in the ground, in a garden bed, in soil around an outdoor potted plant, or the like).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a liquid reservoir;
a liquid permeable cone in fluid communication with the liquid reservoir; and
one or more threads circumscribing the liquid permeable cone such that rotation of the one or more threads into soil places the liquid permeable cone into contact with the soil.

2. The apparatus of claim 1, wherein the liquid permeable cone comprises a ceramic material.

3. The apparatus of claim 2, wherein the ceramic material comprises a terra cotta material.

4. The apparatus of claim 1, wherein the one or more threads comprise a different material than the liquid permeable cone and are placed to provide mechanical support to the liquid permeable cone.

5. The apparatus of claim 1, further comprising one or more additional liquid reservoirs stackable with the liquid reservoir to supplement a liquid storage capacity of the liquid reservoir.

6. The apparatus of claim 1, further comprising an interface between one or more of the liquid permeable cone and the one or more threads and the liquid reservoir.

7. The apparatus of claim 1, further comprising a removable lid for the liquid reservoir.

8. The apparatus of claim 1, wherein the liquid reservoir is at least partially transparent such that contents of the liquid reservoir are visible outside the liquid reservoir.

9. The apparatus of claim 1, further comprising a float extending from the liquid permeable cone into the liquid reservoir, indicating a level of a liquid within the liquid permeable cone.

10. A system comprising:
a plurality of stackable liquid reservoirs;
a liquid permeable cone in fluid communication with the plurality of liquid reservoirs; and
one or more threads circumscribing the liquid permeable cone such that rotation of the one or more threads into soil places the liquid permeable cone into contact with the soil.

11. The system of claim 10, wherein the liquid permeable cone comprises a ceramic material.

12. The system of claim 11, wherein the ceramic material comprises a terra cotta material.

13. The system of claim 10, wherein the one or more threads comprise a different material than the liquid permeable cone and are placed to provide mechanical support to the liquid permeable cone.

14. The system of claim 10, further comprising an interface between one or more of the liquid permeable cone and the one or more threads and the liquid reservoir.

15. The system of claim 10, further comprising a removable lid for the liquid reservoir.

16. The system of claim 10, wherein the plurality of liquid reservoirs are at least partially transparent such that contents of the liquid reservoirs are visible outside the liquid reservoirs.

17. The system of claim 10, further comprising a float extending from the liquid permeable cone into at least one of the plurality of liquid reservoirs, indicating a level of a liquid within the liquid permeable cone.

18. An apparatus comprising:
a liquid reservoir;
a removable lid for the liquid reservoir;
a liquid permeable cone in fluid communication with the liquid reservoir, the liquid permeable cone comprising a ceramic material;
one or more threads circumscribing the liquid permeable cone such that rotation of the one or more threads into soil places the liquid permeable cone into contact with the soil, the one or more threads comprising a different material than the liquid permeable cone and being placed to provide mechanical support to the liquid permeable cone; and
an interface between one or more of the liquid permeable cone and the one or more threads and the liquid reservoir.

19. The apparatus of claim 18, further comprising one or more additional liquid reservoirs stackable with the liquid reservoir to supplement a liquid storage capacity of the liquid reservoir.

20. The apparatus of claim 18, further comprising a float extending from the liquid permeable cone into the liquid reservoir, indicating a level of a liquid within the liquid permeable cone.
